(19) United States
(12) Patent Application Publication
(10) Pub. No.: US 2010/0251232 A1
(43) Pub. Date: Sep. 30, 2010

(54) IMAGE PROCESSING APPARATUS, SOFTWARE DELIVERY SYSTEM, AND INSTALL PROCESSING METHOD

(76) Inventor: Kiyohiko SHINOMIYA, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/719,232

(22) Filed: Mar. 8, 2010

(30) Foreign Application Priority Data
Mar. 30, 2009 (JP) 2009-083197

(51) Int. Cl. G06F 9/445; G06F 15/16

(52) U.S. Cl. 717/177

(57) ABSTRACT

An image processing apparatus, connected with a software delivery server, is provided that includes a storage unit; a requesting unit to transmit an installation request for an install-target software to the software delivery server; a related information receiving unit to receive software information from the software delivery server; a software acquiring unit to acquire the install-target software; a determining unit to determine whether dependency software is included and is firmware; a progress status registering unit to register a progress status of acquiring the install-target software and the firmware; a start-up unit to restart the image processing apparatus; and an installation processing unit to install the install-target software.

### CROSS-REFERENCE TO RELATED APPLICATIONS

The present application claims priority to and incorporates by reference the entire contents of Japanese Patent Application No. 2009-083197 filed in Japan on Mar. 30, 2009.

### BACKGROUND OF THE INVENTION

1. Field of the Invention

The present invention relates to an image processing apparatus, a software distribution system, and an installation processing method for installing software in the image processing apparatus.

2. Description of the Related Art

With recent image processing apparatuses, external applications newly developed by a user or a third vendor, i.e., a third party, can be installed on the image processing apparatus. Various kinds of technology are provided for installing such applications or programs on an MFP after it has been shipped.

Executing such an installation operation sometimes requires software programs, which needs to be installed beforehand (hereinafter, “dependent software”). Unless such installation dependency among software is properly adjusted, software to be installed (hereinafter, “install-target software”) cannot be installed. Thus, technology related to software involving such dependency is known.

For example, Japanese Patent Publication No. 3602036 discloses technology that determines whether programs can be run based on how hardware is equipped and considers installation dependency in order to execute an installation.

Further, Japanese Patent Application Laid-open No. 2007-110628 discloses technology that determines, upon an instruction to launch an installed application, whether a launch-target application can be launched based on application dependency.

Further, Japanese Patent Application Laid-open No. 2005-044011 discloses technology that stores dependency among software beforehand and manages the software installation order.

Although with the technology in Japanese Patent Publication No. 3602036, the dependency between software and hardware may be considered in installing software, the dependency between one software and another or the dependency between software and firmware is not considered. Thus, there is a problem that software is installed without considering the dependency between one software and another, or the dependency between software and firmware.

Further, the technology in Japanese Patent Application Laid-open No. 2007-110628 does not disclose detailed processes about the availability of launching based on software dependency. Thus, there is a problem that installation cannot be executed properly considering the dependency between one software and another, or the dependency between software and firmware.

Further, the technology in Japanese Patent Application Laid-open No. 2005-044011 can be applied only to a method where information related to software is stored beforehand with a directed graph. Thus, there is a problem that software installation cannot be executed properly with considering the dependency between one software and another, or the dependency between software and firmware.

### SUMMARY OF THE INVENTION

It is an object of the present invention to at least partially solve the problems in the conventional technology.

According to an aspect of the present invention, there is provided an image processing apparatus that is connected with a software delivery server that delivers software, comprising a storage unit; a requesting unit that transmits an installation request specifying an install-target software to the software delivery server; a related information receiving unit that receives software information, indicating information on the install-target software, from the software delivery server as a response to the installation request; a software acquiring unit that acquires the install-target software; a determining unit that determines whether dependency information on dependency software that needs to be installed before the install-target software is installed in the software information and, when the dependency information is registered in the software information, further determines whether the dependency software is firmware; a dependency software acquiring unit that acquires the dependency software when the dependency information is registered in the software information; a progress status registering unit that registers, when the dependency information is firmware, a progress status indicating a step at which the install-target software and the firmware have been acquired in the storage unit; a start-up unit that restarts, when the dependency software is firmware, the image processing apparatus; and an installation processing unit that refers to the progress status and, after restarting by the start-up unit, carries out the installation process of the install-target software.

According to another aspect of the present invention, there is provided a software delivery system comprising: a software delivery server that delivers software; and an image processing apparatus that is connected with the software delivery server via a network and installs the software, the image forming apparatus including a first storage unit; a requesting unit that sends an installation request specifying install-target software to the software delivery server; a related information receiving unit that receives software information, indicating information on the install-target software, from the software delivery server as a response to the installation request; a software acquiring unit that acquires the install-target software; a determining unit that determines whether dependency information on dependency software that needs to be installed before the install-target software is installed in the software information and, when the dependency information is registered in the software information, further determines whether the dependency software is firmware; a dependency software acquiring unit that acquires the dependency software when the dependency information is registered in the software information; a progress status registering unit that registers, when the dependency information is firmware, a progress status indicating a step at which the install-target software and the firmware have been acquired in the first storage unit; a start-up unit that restarts, when the dependency software is firmware, the image processing apparatus; and an installation processing unit that refers to the progress status and, after the restarting, carries out the installation process of the install-target software; and the software delivery server including a second storage unit that stores therein the software information for each software; a request receiving unit that receives the installation request; and a related information transmission unit that acquires the software information on the install-target software, to which the installation request has been sent, from the second storage unit and transmits the software information acquired to the image processing apparatus as a response to the installation request.

According to still another aspect of the present invention, there is provided an installation method that is employed in a software delivery system including a software delivery server that delivers software and an image processing apparatus that is connected with the software delivery server via a network and installs the software, the image forming apparatus including a first storage unit and the software delivery server including a second storage unit that stores therein the software information indicating information on each software, the installation method comprising: a requesting step where a requesting unit of the image processing apparatus sends an installation request specifying install-target software to the software delivery server; a step where a request receiving unit of the software delivery server receives the installation request; a step where a related information transmission unit of the software delivery server transmits the software information on the install-target software, to which the installation request has been sent, and the install-target software to the image processing apparatus as a response to the installation request; a step where a related information receiving unit of the image processing apparatus receives the software information of the install-target software as a response to the installation request; a step where a software acquiring unit of the image processing apparatus acquires the install-target software; a step where a determining unit of the image processing apparatus determines whether dependency information on dependency software that needs to be installed before the install-target software is installed and, when the dependency information is registered in the software information, further determines whether the dependency software is firmware; a step where a dependency software acquiring unit of the image processing apparatus acquires the dependency software when the dependency information is registered in the software information; a step where a progress status registering unit of the image processing apparatus registers, when the dependency information is firmware, a progress status indicating that the install-target software and the firmware have been acquired in the first storage unit; a step where the start-up unit of the image processing apparatus restarts, when the dependency software is firmware, the image processing apparatus; and a step where an installation processing unit of the image processing apparatus, after the restarting, refers to the progress status and carries out the installation process of the install-target software.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating a network configuration of a software delivery system with which an MFP 100 in accordance with a first embodiment is connected;

FIG. 2 is a block diagram illustrating a functional configuration of an MFP 100 in accordance with the first embodiment;

FIG. 3 is a block diagram illustrating a functional configuration of an application-installation control service 131 in accordance with the first embodiment;

FIG. 4 is an explanatory diagram illustrating apparatus information;

FIG. 5 is an explanatory diagram illustrating instruction information;

FIG. 6 is an explanatory diagram illustrating package information;

FIG. 7 is an explanatory diagram illustrating a progress status;

FIG. 8 is a block diagram illustrating a functional configuration of a software delivery server 500;

FIG. 9 is a sequence diagram illustrating a flow of a software delivery process;

FIG. 10 is a flowchart illustrating a procedure of an instruction information generating process;

FIG. 11 is a flowchart illustrating the procedure of an installation process in accordance with a first embodiment;

FIG. 12 is a flowchart illustrating a procedure (subsequent to FIG. 11) of an installation process in accordance with the first embodiment;

FIG. 13 is a flowchart illustrating a procedure of an installation continuation process;

FIG. 14 is a block diagram illustrating a functional configuration of an application-installation control service 1431 of an MFP in accordance with a second embodiment;

FIG. 15 is a flowchart illustrating a procedure of an installation process in accordance with the second embodiment;

FIG. 16 is a block diagram illustrating a functional configuration of an application-installation control service 1631 of an MFP in accordance with a third embodiment;

FIG. 17 is a flowchart illustrating a procedure of an installation process in accordance with the third embodiment;

FIG. 18 is a block diagram illustrating a functional configuration of an application-installation control service 1831 of an MFP in accordance with a fourth embodiment;

FIG. 19 is a flowchart illustrating a procedure of an installation process in accordance with the fourth embodiment;

FIG. 20 is a block diagram illustrating a functional configuration of an application-installation control service 2031 of an MFP in accordance with a fifth embodiment;

FIG. 21 is a flowchart illustrating a procedure of an installation process in accordance with a fifth embodiment; and

FIG. 22 is a block diagram illustrating a hardware configuration of an MFP 100 in accordance with the above embodiments.

### DETAILED DESCRIPTION OF THE PREFERRED EMBODIMENTS

Exemplary embodiments of an image processing apparatus, a software delivery system, and an installation process method are described in detail below with reference to accompanying drawings.

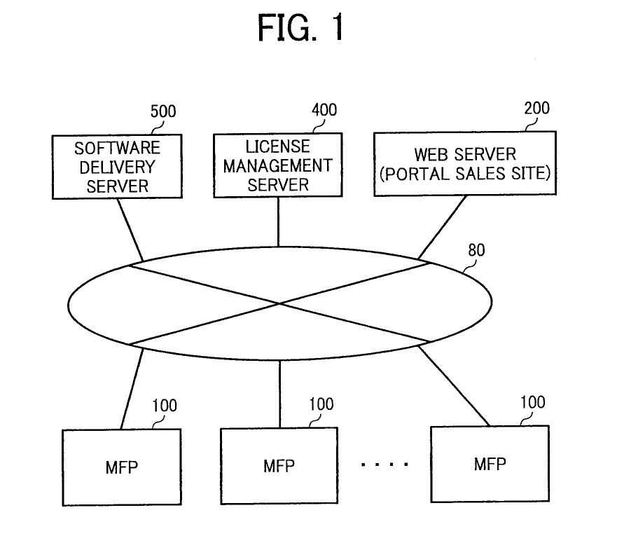

FIG. 1 is a schematic diagram illustrating a network configuration of a software delivery system with which an MFP 100 in accordance with a first embodiment is connected. As illustrated in FIG. 1, a software delivery system of the present embodiment includes a plurality of MFPs 100, a software delivery server 500, a license management server 400, and a web server 200. These components are connected together on a network 80, e.g., the Internet. The number of MFPs 100 connected with the software delivery server 500 may be one.

The software delivery server 500 stores therein and manages packages including software and firmware of various kinds of applications. In response to an installation request from the MFP 100 (client), the software delivery server 500, a server apparatus, downloads software of an install-target application specified by the installation request, package information (software information) on the software, and instruction information indicating instructions on how to carry out the installation process onto the MFP 100.

The license management server 400 is a server apparatus that manages the license (right to use) for software installed on the MFP 100 (client). Specifically, the license management server 400 transmits a license file of the software in response to an activation request from each MFP 100. The license file is data containing descriptions on software license.

There are the following types of license.

The first type is a monthly fixed contract. The monthly fixed contract offers the right to use the functions to a client for a fixed charge. In this case, an official license is transmitted as the license file.

The second type is a specific charge contract. The specific charge contract leases the right to use the functions to a client with charge based on how much the functions are used (sliding fee). In this case, an official license is transmitted as the license file.

The third type is a limited-time usage contract. The limited-time usage contract leases the right to use the functions to a client for the period of time specified in the contract. In this case, an official license with the limitation is transmitted as the license file.

The fourth type is a sellout contract. The sellout contract sells right the right to use the functions to a client. In this case, an official license without any limitation is transmitted as the license file.

The fifth type is a trial contract. The trial contract leases the right to use the functions for a limited period of time without charge. In this case, a starter license (trial license) is transmitted as the license file.

The web server 200 is a server apparatus that hosts a portal sales site for software, e.g., of applications. A user accesses to the portal sales site using the MFP 100 or a PC (Personal Computer, not shown), for example, and buys the desired application software.

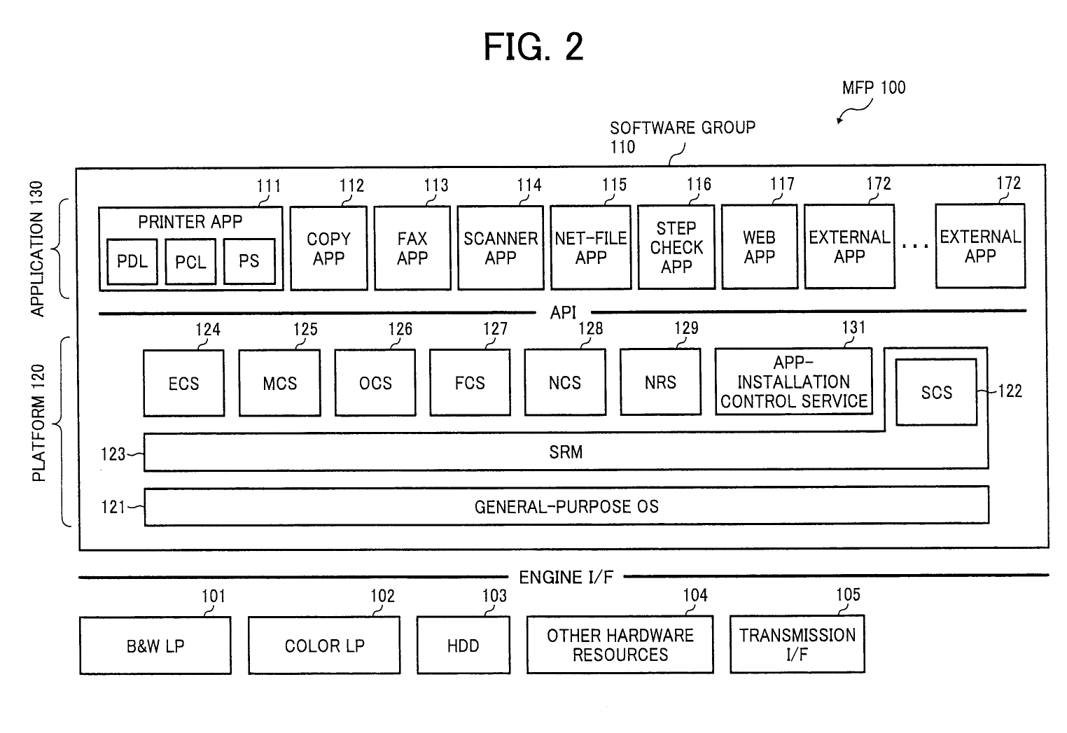

Features of the MFP 100 are described below. FIG. 2 is a block diagram illustrating a functional configuration of the MFP 100 in accordance with the first embodiment. As illustrated in FIG. 2, the MFP 100 includes a black-and-white laser printer (B&W LP) 101, a color laser printer (Color LP) 102, an HDD (Hard Disk Drive) 103, a hardware resource 104 such as scanner, facsimile, and memory, a transmission I/F (interface) 105, and a software group 110 consisting of a platform 120 and an application 130.

In the MFP 100 of the present embodiment, the HDD 103 stores therein apparatus information, a software package, firmware package, package information, instruction information indicating instructions on how to operate the installation process of an application downloaded from the software delivery server 500, and a license file for an application downloaded from the license management server 400.

The platform 120 includes a control service that interprets a processing request from an application and generates an obtaining request for a hardware source, a system resource manager (SRM) 123 that manages one or more hardware resources and arranges an obtaining request from the control service, and a general-purpose OS (Operating System) 121.

The control service consists of a plurality of service modules. The control service includes an SCS (System Control Service) 122, an ECS (Engine Control Service) 124, an MCS (Memory Control Service) 125, an OCS (Operation Panel Control Service) 126, an FCS (Fax Control Service) 127, an NCS (Network Control Service) 128, an NRS (New Remote Service) 129, and an application-installation control service 131. The platform 120 includes an application program interface (API) that can receive a processing request from the application 130 using a predetermined function.

The general-purpose OS 121 is a general-purpose operating system such as UNIX (registered trademark). The general-purpose OS 121 operates each piece of software of the platform 120 and the application 130 as parallel processes.

The process of the SRM 123 carries out, similarly to the SCS 122, system control and resource management. The process of the SRM 123 carries out the arrangement and the operation control according to a request from an upper layer, which uses a hardware resource such as an engine, memory, HDD file, and host I/O (e.g., Centronics I/F, network I/F, IEEE 1394 I/F, RS232C I/F).

Specifically, the SRM 123 determines whether the requested hardware resource is available (whether the hardware resource is in use or not because of another request). When it is determined that the hardware resource is available, the SRM 123 notifies the upper layer of the result that the requested hardware resource is available. Further, the SRM 123 adjusts the schedule by which the hardware resource is used according to a request from the upper layer and then directly carries out what is requested (e.g., paper feeding, image forming, memory securement, and file generation using a printer engine).

The process of the SCS 122 carries out application management, operating unit control, system screen display, LED display, resource management, interruption application control, and the like.

The process of the ECS 124 carries out engine control for the hardware resource 104 such as a black-and-white laser printer 101, the color laser printer (Color LP) 102, scanner, and facsimile.

The process of the MCS 125 carries out the acquisition or release of image memory, hard-disk apparatus (HDD) use, and compression and depression of image data.

The process of the FCS 127 provides an API for carrying out facsimile transceiving with a PSTN/ISDN network from each application layer of the system controller, registration/citation of various kinds of facsimile data managed in the BKM (backup SRAM), facsimile scanning, facsimile-reception printing, and fused sending transceiving.

The process of the NCS 128 provides services commonly available for an application involving network I/O. The NCS 128 distributes data, received via each protocol from the network, to each application and relays data when the data is transmitted from the application to the network.

The process of the OCS 126 controls an operation panel (control panel) that is used for communicating information between the operator (user) and the main control. The operation panel consists of an OCS process, which receives key pushdown (or touch operation) as a key event and then transmits a key event function corresponding to the received key to the SCS 122, and an OCS library in which functions for other operational panels are previously registered. The OCS library is implemented by being linked to the application 130 and each module of the control service. The OCS 126 as a whole may be operated as a process or may be realized as an OCS library.

The process of the application-installation control service 131 controls installation of the application into the MFP 100. The application-installation control service 131 will be described in detail.

The process of the NRS 129 includes a function for operating an apparatus by remote control via a network, e.g., converting data to be transmitted or received via the network, and a scheduler function.

The application 130 includes a printer application 111 that is an application for a printer with a page description language (PDL), PCL, and post script (PS); a copy application 112 that is an application for a copier; a fax application 113 that is an application for a facsimile; a scanner application 114 that is an application for a scanner; a net-file application 115 that is an application for a network file; a step-examination application 116 that is an application for examining steps; and a web application 117 that functions as a web browser of a client terminal of a PC connected to the Internet and displays various kinds of screens on the Web browser of the client terminal.

Each process of the application 130 and each process of the control service carries out process-to-process communication by calling a function and transmitting a return value or transceiving a message, thereby providing user services related to an image forming process such as copying, printing, scanning, and facsimile.

The MFP 100 in accordance with the first embodiment involves the plurality of applications 130 and a plurality of control services, each one of which operates as a process. Each process constitutes one or more threads, and parallel execution of each thread is carried out. The control service provides common service for the application 130. These many processes are executed in parallel while the threads are executed in parallel. Thus, the process-to-process communication is carried out as the coordinated operation, so that user service related to an image forming process such as copying, printing, scanning, and facsimile sending/receiving is provided.

Further, the MFP 100 allows a third party, e.g., a client of the MFP 100 and a third vendor, to develop an external application 172 for the application layer, which is above the control service layer. The external application 172 is an application that is downloaded from the software delivery server 500 and installed via the application-installation control service 131. FIG. 2 illustrates how the application is operated.

In the MFP 100 in accordance with the first embodiment, the processes of the applications 130 and the processes of the control services are operated. The number of processes of the applications 130 and the control services may configure to be one and one, respectively. Further, the applications 130 may be added or removed for each one of them, i.e., as described, the external application 172 will be installed and uninstalled.

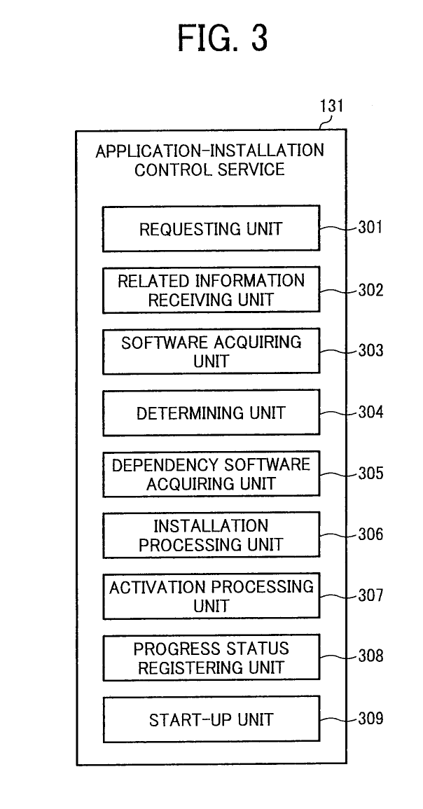

The application-installation control service 131 can be described in detail. FIG. 3 is a block diagram illustrating a functional configuration of the application-installation control service 131 in accordance with the first embodiment. As illustrated in FIG. 3, the application-installation control service 131 of the present embodiment includes, mainly, a requesting unit 301, a related information receiving unit 302, a software acquiring unit 303, a determining unit 304, a dependency software acquiring unit 305, an installation processing unit 306, an activation processing unit 307, a progress status registering unit 308, and a start-up unit 309.

The requesting unit 301 transmits, via the NCS 128, a software-installation request of an application specified by a user to the software delivery server 500 along with the apparatus information stored in the HDD 103.

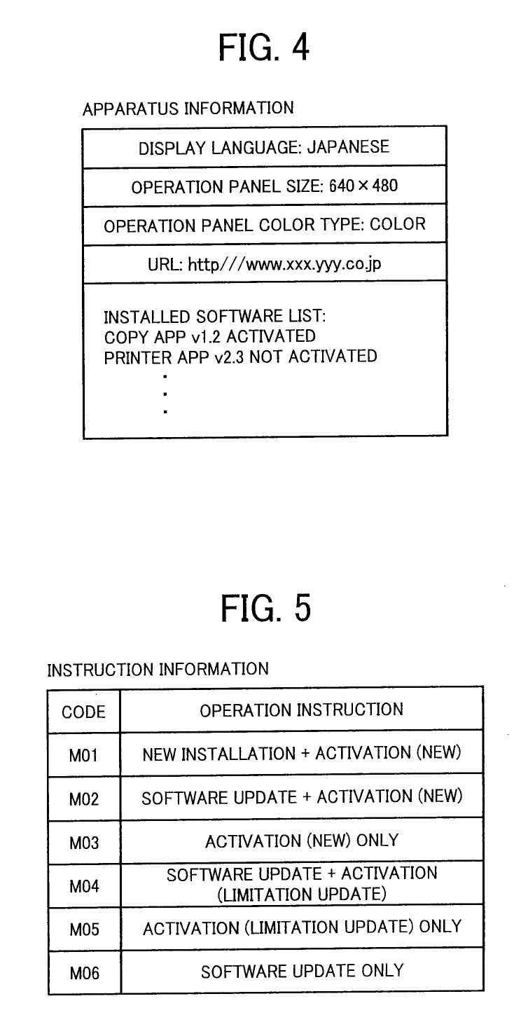

The apparatus information is data illustrating various kinds of settings for the MFP 100 and a list of software or applications installed on the MFP 100 (a list of installed software). FIG. 4 is an explanatory diagram illustrating apparatus information. In the example in FIG. 4, the display language on the control panel (operation panel), an operation panel size, the URL of the MFP 100, and a list of installed software are registered as the apparatus information.

A title, a version of the software, and information on whether it is activated or not is registered in association with each other as the list of installed software.

In response to the installation request, the related-information receiving unit 302 downloads, via the NCS 128, package information of a software package of an application and instruction information transmitted from the software delivery server 500.

The instruction information is data that is generated in the software delivery server 500 on the basis of the contents of the list of installed software in the apparatus information. The instruction information includes a series of operation instructions for installation and activation. FIG. 5 is an explanatory diagram illustrating instruction information.

As illustrated in FIG. 5, the instruction information consists of codes and operation instructions corresponding to the codes. The MFP 100 carries out the software installation process according to the operation instructions corresponding to the code of the instruction information received from the software delivery server 500. For example, when the operation instruction is M01, the MFP 100 carries out a new installation and new activation of software. Further, when the operation instruction is M04, the MFP 100 carries out an update of software and activation of a limitation update.

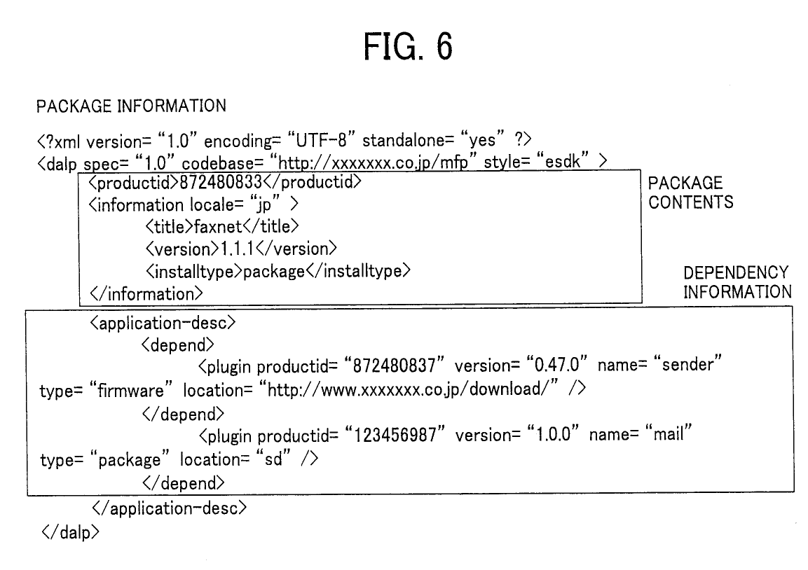

Further, the package information is data in which dependency information on dependency software is registered; the dependency software involves dependency and needs to be installed before the installing the contents of a software package or the software. FIG. 6 is an explanatory diagram illustrating package information. Although the package information of the present embodiment consists of XML format data, the package information is not limited to this type of format.

As illustrated in FIG. 6, the package information consists of package contents and dependency information. In the package contents, an ID for identifying software is registered in the <productid> tag, and the version and the like of the software are registered in the <version> tag.

Dependency information is content described in the <depend> tag. In the dependency information, an ID for identifying dependency software is registered in the <plugin productid> tag, information on whether it is firmware dependent is registered in the <type> tag, and the destination address of dependency software is registered in the <location> tag (the default address is that of a software delivery server and is used when it is omitted).

Referring back to FIG. 3, the software acquiring unit 303 downloads, via the NCS 128, a software package of an application transmitted from the software delivery server 500 in response to the installation request.

The determining unit 304 refers to package information to check whether there is the <depend> tag, so that the determining unit 304 can determine whether dependency information on dependency software, which needs to be installed before installing the target software, is registered or not. When the dependency information is registered, the determining unit 304 determines, based on the contents of the <type> tag described in the dependency information, whether the dependency software is firmware or not.

The dependency software acquiring unit 305 downloads via the NCS 128 the software or firmware package of the application that is dependency software from the destination address registered in the <location> tag in the dependency information. Specifically, the dependency software acquiring unit 305 searches for an ID that is set in the <plugin productid> in the dependency information from the software delivery server 500 and carries out downloading.

Although the present embodiment describes a case where the dependency software is downloaded from the software delivery server 500, the present embodiment is not limited to this case.

The installation processing unit 306 carries out a process of installing software and firmware of the downloaded application according to the instruction information.

The activation processing unit 307 carries out a process of activating software and firmware of the installed application. Specifically, when there is the activation instruction of the instruction information, the activation processing unit 307 accesses to the license management server 400, downloads a license file in which the license ID and the expiration date of software and firmware are registered, and activates the software and firmware.

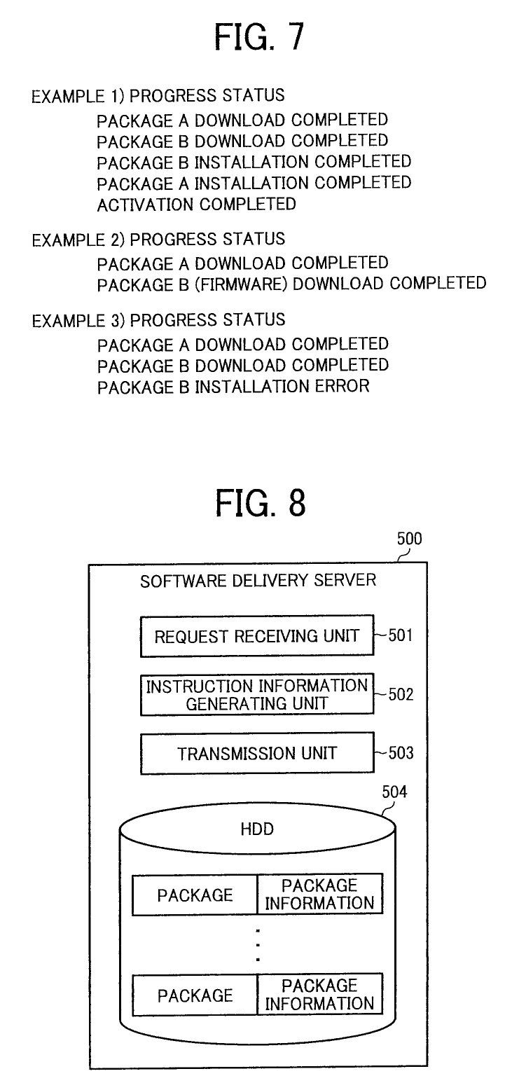

The progress status registering unit 308 registers in the HDD 103 progress statuses at each step of a series of an installation process and an activation process. FIG. 7 is an explanatory diagram illustrating an exemplary progress status. Example 1 in FIG. 7 illustrates a case where the installation process and the activation process are normally ended. Example 2 illustrates an exemplary progress status at the instance when a restart is carried out to install the firmware that as dependency software. Example 3 illustrates an exemplary progress status when an error occurs during the installation.

Referring back to FIG. 3, the start-up unit 309 sends a reboot instruction to the general-purpose OS 121 and restarts the MFP 100. The start-up unit 309 also specifies the mode of the restart as the normal mode or safe mode.

Details of the software delivery server 500 are described in the following. FIG. 8 is a block diagram illustrating a functional configuration of the software delivery server 500. As illustrated in FIG. 8, the software delivery server 500 mainly includes a request receiving unit 501, an instruction information generating unit 502, a transmission unit 503, and an HDD 504.

The HDD 504 can store the package of the software and the package information in association with each other.

The request receiving unit 501 receives an installation request that specifies the install-target software and that includes the apparatus information from the MFP 100.

The instruction information generating unit 502 generates the instruction information from the list of installed software of the received apparatus information.

The transmission unit 503 transmits the package of software and the package information specified according to the installation request, the package of dependency software, and the generated instruction information to the MFP 100.

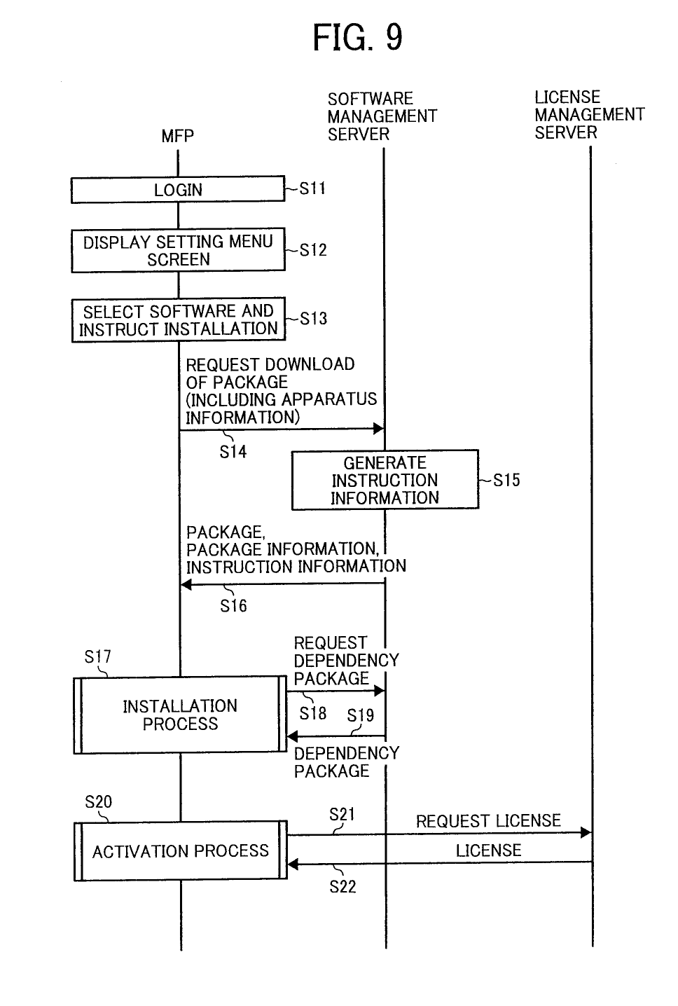

A software delivery process in the software delivery system of the present embodiment configured as above is described below. FIG. 9 is a sequence diagram illustrating a flow of a software delivery process.

A user carries out a login process of the MFP 100 first (Step S11), and the MFP 100 displays a setting menu screen on the operation panel (Step S12). The user selects the install-target application software from the setting menu screen and sends an installation instruction, which is then received by the MFP 100 (Step S13). The installation request including the apparatus information, i.e., a download request of the software package, is sent from the MFP 100 to the software delivery server 500 (Step S14).

When the software delivery server 500 receives such a request, the instruction information generating unit 502 generates the instruction information (Step S15). Then the transmission unit transmits the software package, the package information, and the instruction information to the MFP 100 (Step S16).

The MFP 100 carries out the installation process (Step S17). During the installation process, requesting for the dependency software package to the software delivery server 500 (Step S18) and downloading of the dependency software package (Step S19) are carried out.

After the software and the dependency software are installed in the MFP 100, the activation process is carried out (Step S20). During the activation process, requesting for license to the license management server 400 (Step S21) and downloading of the license file (Step S22) are carried out.

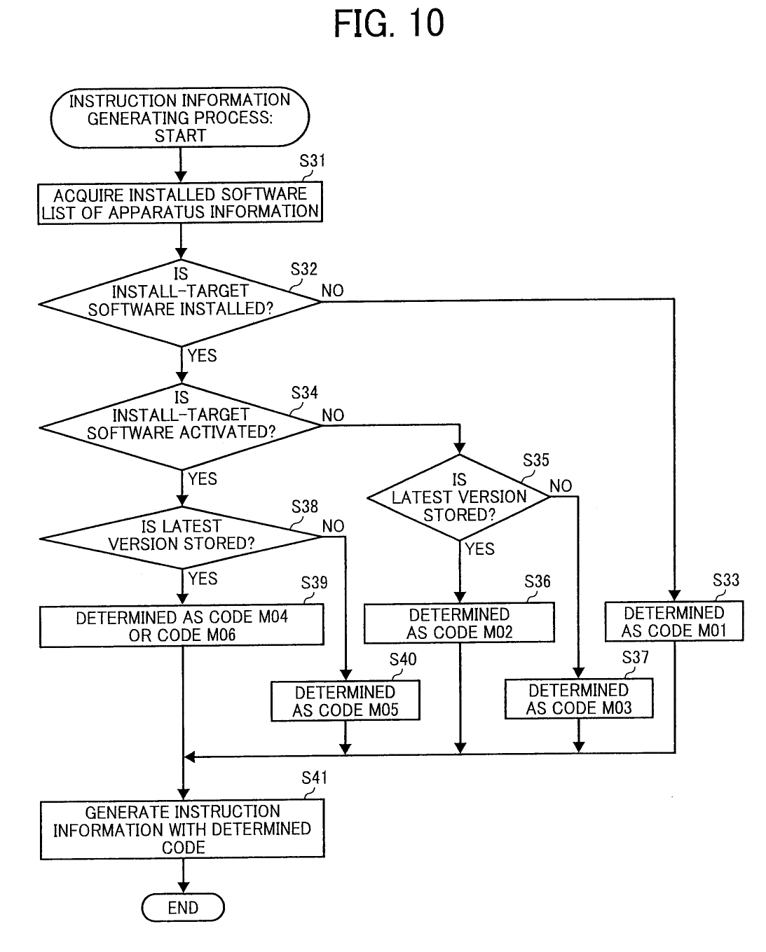

The instruction information generating process at Step S15 performed in the software delivery server 500 is described below. FIG. 10 is a flowchart illustrating a procedure of the instruction information generating process.

The instruction information generating unit 502 obtains a list of installed software included in the apparatus information that is received from the MFP 100 (Step S31), and determines whether the installed software specified by the installation request has been installed or not (Step S32).

When the software is not installed yet (Step S32: No), the instruction information code is determined as M01 (Step S33).

When the software is already installed (Step S32: Yes), the instruction information generating unit 502 determines whether the activation of the install-target software has been carried out or not (Step S34). When the activation is not carried out yet (Step S34: No), the instruction information generating unit 502 determines whether the latest version of the install-target software is stored in the HDD 504 or not (Step S35). When the latest version is stored there (Step S35: Yes), the instruction information code is determined as M02 (Step S36). In contrast, when the latest version is not stored in the HDD 504 (Step S35: No), the instruction information code is determined as M03 (Step S37).

When the activation of the install-target software is already completed at Step S34 (Step S34: Yes), the instruction information generating unit 502 further determines whether the latest version of the install-target software is stored in the HDD 504 or not (Step S38). When the latest version is found (Step S38: Yes), the instruction information code is determined as M04 or M06 (Step S39).

The code M04 is used for the license update, e.g., for updating the limitation or for switching from a trial license to paid-for one. The code M06 is used for a software update.

When the latest version is not stored in the HDD 504 (Step S38: No), the instruction information code is determined as M05 (Step S40).

After the code is determined as described above, the instruction information generating unit 502 generates data including the determined code as the instruction information (Step S41).

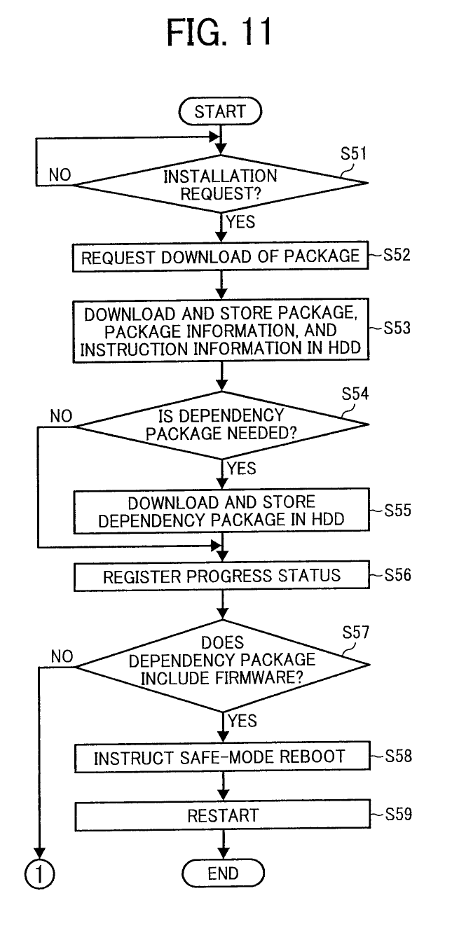

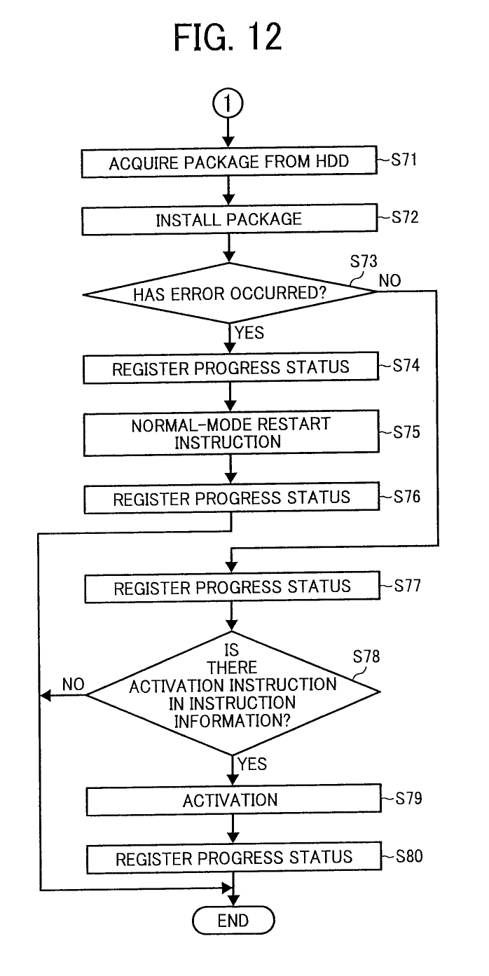

The installation process performed in the MFP 100 is described below. FIGS. 11 and 12 are a flowchart of a procedure of the installation process in accordance with the first embodiment.

The requesting unit 301 of the application-installation control service 131 receives the installation instruction from the user (Step S51: Yes) and carries out a download request (installation request) for the install-target software package to the software delivery server 500 (Step S52). The request includes the apparatus information.

The software acquiring unit 303 downloads the install-target software package from the software delivery server 500 while the related information receiving unit 302 downloads the package information and the instruction information; these files are stored in the HDD 103 (Step S53).

The determining unit 304 refers to the package information and determines whether the dependency software package is needed or not based on whether there is dependency information (Step S54). The dependency software acquiring unit 305 downloads the dependency software package from the software delivery server 500 and stores the software package in the HDD 103 (Step S55). The progress status registering unit 308 registers the progress status indicating that the install-target software package and the dependency software package have been downloaded in the HDD 103 (Step S56).

The determining unit 304 refers to <type> in the dependency information and determines whether the dependency software includes firmware or not (Step S57).

When the dependency software does not include firmware (Step S57: No), the installation processing unit 306 obtains the install-target software package from the HDD 103 (Step S71) and carries out an installation process (Step S72).

When an error occurs during the installation (Step S73: Yes), the progress status registering unit 308 registers the progress status indicating that an error has occurred during the installation of the package in the HDD 103, as illustrated in Example 3 in FIG. 7 (Step S74). The start-up unit 309 then sends a normal-mode reboot instruction (Step S75), which causes the MFP 100 to restart (Step S76).

When the installation process is finished without occurring any error at Step S73 (Step S73: No), the progress status registering unit 308 registers a progress status indicating that the installation has been completed in the HDD 103 (Step S77). The activation processing unit 307 determines whether there is an activation instruction in the instruction information (Step S78). When there is an activation instruction (Step S78: Yes), the activation processing unit 307 then carries out the activation process (Step S79). The progress status registering unit 308 registers a progress status indicating that the activation process has been completed in the HDD 103 as illustrated in Example 1 in FIG. 7 (Step S80).

When the dependency software includes the firmware at Step S57 (Step S57: Yes), the start-up unit 309 sends a safe-mode reboot instruction (Step S58), which causes the MFP 100 to restart (Step S59).

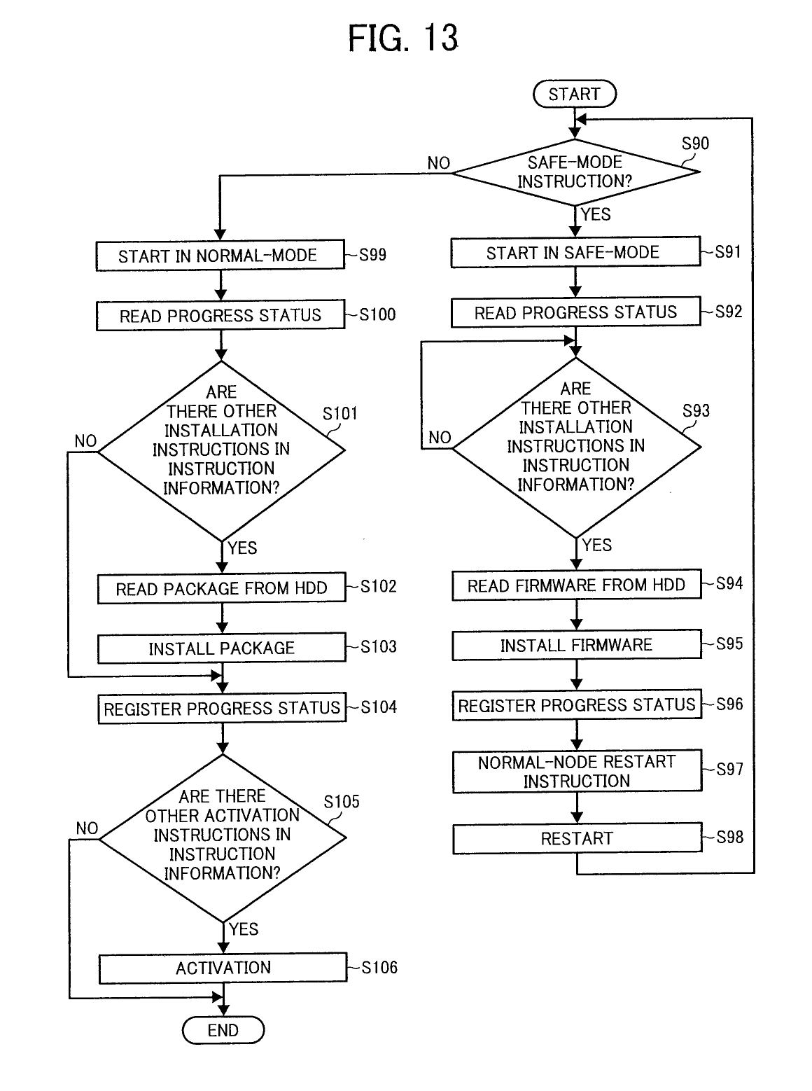

An installation continuation process after the restart of the MFP 100 is described below. FIG. 13 is a flowchart illustrating a procedure of the installation continuation process. The MFP 100 determines whether there is an instruction indicating that the MFP 100 is to be started in the safe mode (Step S90). When there is an instruction of the safe mode (Step S90: Yes), the MFP 100 is started in the safe mode (Step S91).

The determining unit 304 reads the progress status stored in the HDD 103 (Step S92) to check the current status and then determine whether there is another installation instruction remaining in the instruction information (Step S93).

When there is another installation instruction (Step S93: Yes), i.e., when the firmware installation is not completed yet, the installation processing unit 306 obtains the firmware package from the HDD 103 (Step S94) and installs the obtained firmware (Step S95). The progress status registering unit 308 registers in the HDD 103 the progress status indicating that the firmware has been installed (Step S96).

The start-up unit 309 sends a normal-mode reboot instruction (Step S97), which causes the MFP 100 to restart (Step S98). After that, the procedure returns to Step S90.

When there is a normal-mode instruction at Step S90 (Step S90: No), the MFP 100 is started in the normal mode (Step S99).

The determining unit 304 reads the progress status stored in the HDD 103 (Step S100) to check the current status and then determines whether there is another installation instruction remaining in the instruction information (Step S101).

When there is another installation instruction (Step S101), i.e., which is a restart after an error or which is an installation continuation after a firmware installation, the installation processing unit 306 obtains the software package from the HDD 103 (Step S102) and installs the obtained software package (Step S103). The progress status registering unit 308 registers in the HDD 103 a progress status indicating that the software installation has been completed (Step S104).

The activation processing unit 307 determines whether there is an activation instruction in the instruction information (Step S105). When there is an activation instruction (Step S105: Yes), the activation processing unit 307 carries out the activation process (Step S106). The progress status registering unit 308 registers in the HDD 103 a progress status indicating that the activation process has been completed as illustrated in Example 1 in FIG. 7. In this way, the series of installation processes and activation processes are completed.

As described, in the first embodiment, the MFP 100 obtains the software package and the package information according to the installation request. When there is firmware as dependency software in the package information, the progress status is registered, the MFP 100 is restarted, and, after the restarting, the firmware installation and the software installation are carried out. Further, when there is dependency software in the package information, the install-target software installation and the dependency software installation are carried out. According to the present embodiment, the software can be properly installed considering the dependency between one software and another, or between software and firmware.

When an error occurs during the software installation in the present embodiment, the MFP is restarted after the progress status is registered, and, after the restarting, the software installation is continued. Therefore, even when an installation error occurs, the software can be properly installed considering dependency between one software and another, or between software and firmware.

In the first embodiment, the dependency software is downloaded from the software delivery server 500, but in a second embodiment, the dependency software is obtained from an external storage medium such as an SD card (Secure Digital Card) and is installed therefrom.

In the present embodiment, the network configuration of the software delivery system, the entire configuration of the MFP 100, and the functional configuration of the software delivery server 500 are the same as those in the first embodiment.

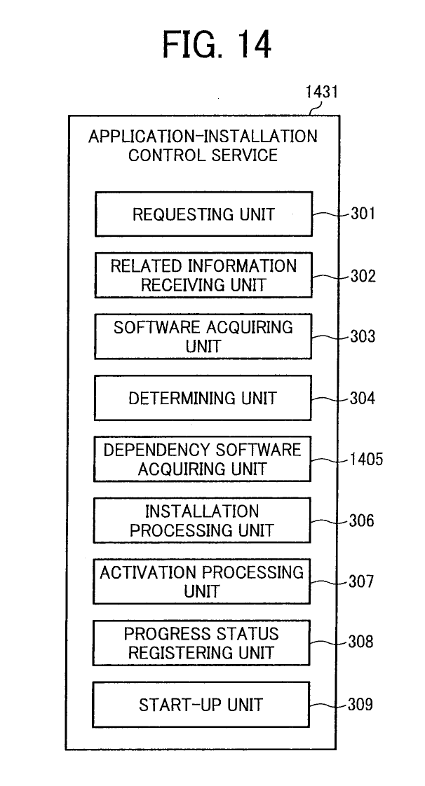

FIG. 14 is a block diagram illustrating a functional configuration of an application-installation control service 1431 of the MFP in accordance with the second embodiment. As illustrated in FIG. 14, the application-installation control service 1431 of the present embodiment mainly includes the requesting unit 301, the related-information receiving unit 302, the software acquiring unit 303, the determining unit 304, a dependency software acquiring unit 1405, the installation processing unit 306, the activation processing unit 307, the progress status registering unit 308, and the start-up unit 309.

The functions and configurations of the requesting unit 301, the related-information receiving unit 302, the software acquiring unit 303, the determining unit 304, the installation processing unit 306, the activation processing unit 307, the progress status registering unit 308, and the start-up unit 309 are the same as those in the first embodiment.

When dependency information is registered in the package information, the dependency software acquiring unit 1405 acquires the package of the application software or the firmware that is dependency software from the external storage medium such as an SD card. When the dependency software is not stored in the external storage medium such as an SD card, the dependency software acquiring unit 1405 downloads the dependency software from the software delivery server 500 or from a destination address specified in the <location> tag in the package information. When the dependency software is not stored in the external storage medium such as an SD card, the dependency software acquiring unit may search for the dependency software via the network according to the default setting of the MFP 100, and when the dependency software is not found as a result of the search, may acquire the dependency software from the destination address specified in the <location> tag in the package information.

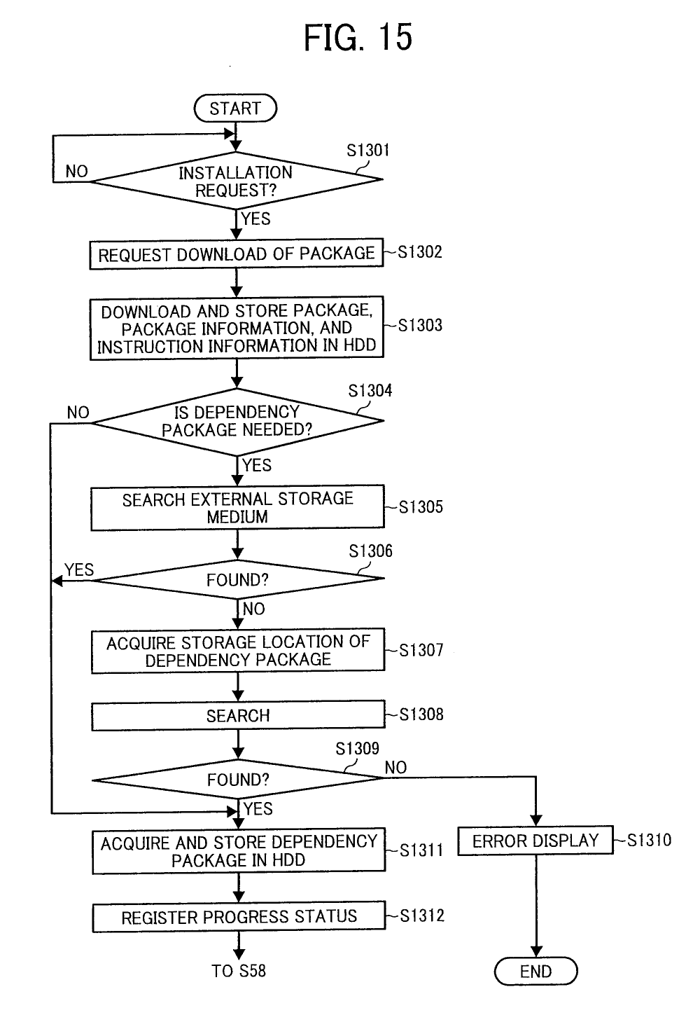

The installation process in the second embodiment with the above configuration is described below. FIG. 15 is a flowchart illustrating a procedure of the installation process of the second embodiment. The processes from Step S1301 to S1304 are the same as those in the first embodiment.

When it is determined that the dependency software package is needed according to the package information at Step S1304 (Step S1304: Yes), the dependency software acquiring unit 1405 searches the external storage medium such as an SD card attached to the MFP 100 for the dependency software (Step S1305). When the dependency software is stored in the external storage medium such as an SD card (Step S1306), the dependency software acquiring unit 1405 acquires the dependency software from the external storage medium such as an SD card and stores the dependency software in the HDD 103 (Step S1311). The subsequent processes are performed in the same way as those in the first embodiment.

When the dependency software is not stored in the external storage medium, such as an SD card, at Step S1306 (Step S1306: No), the dependency software acquiring unit 1405 acquires the storage location specified in the <location> tag in the dependency information of the package information (Step S1307) and searches the storage location for the dependency software package (Step S1308). When the dependency software is found as a result (Step S1309: Yes), the dependency software acquiring unit 1405 downloads the dependency software from the storage location and stores the same in the HDD 103 (Step S1311). The subsequent processes are performed in the same way as that in the first embodiment.

When the dependency software package is not stored in the specified storage location at Step S1309 (Step S1309: No), an indication of an error is displayed on the operation panel (Step S1310) and the procedure is terminated (Steps 1311 and 1312).

In the second embodiment, the dependency software that has dependency with the install-target software is acquired from the external storage medium such as an SD card and installed. Therefore, even when the external storage medium is used for the installation, the software can be properly installed considering the dependency between one software and another, or between software and firmware.

When there is dependency software in the first and second embodiments, the dependency software is always installed. In a third embodiment, the installation process is not carried out when the dependency software is paid-for software.

The network configuration of the software delivery system, the entire configuration of the MFP 100, and the functional configuration of the software delivery server 500 of the present embodiment are the same as those in the first embodiment.

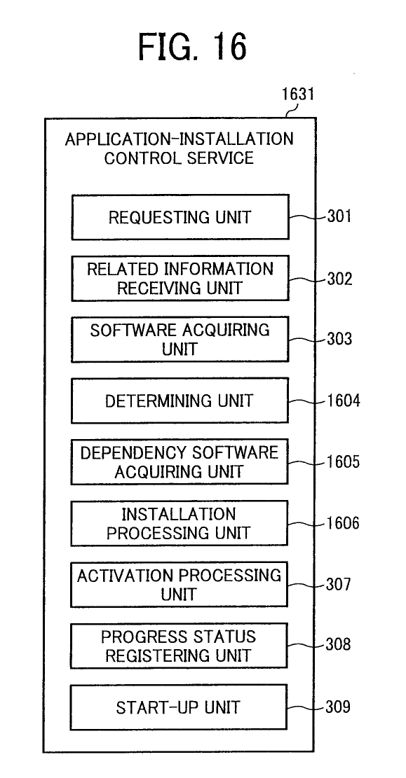

FIG. 16 is a block diagram illustrating a functional configuration of the application-installation control service 1631 of the MFP in accordance with the third embodiment. As illustrated in FIG. 16, an application-installation control service 1631 of the present embodiment includes the requesting unit 301, the related information receiving unit 302, the software acquiring unit 303, a determining unit 1604, a dependency software acquiring unit 1605, an installation processing unit 1606, the activation processing unit 307, the progress status registering unit 308, and the start-up unit 309.

The functions and configurations of the requesting unit 301, the related information receiving unit 302, the software acquiring unit 303, the activation processing unit 307, the progress status registering unit 308, and the start-up unit 309 are the same as those in the first embodiment.

When there is dependency software as a result of the determination by the determining unit 1604 on whether there is dependency software, the determining unit 1604 determines whether the dependency software is paid-for software on the basis of the dependency information of the package information. Specifically, because whether it is paid-for software is specified by the <type> tag in the dependency information, the determining unit 1604 refers to the <type> tag and determines whether it is paid-for software.

When the dependency software is paid-for software, the dependency software acquiring unit 1605 does not carry out the acquisition of the dependency software. Therefore, when the dependency software is paid-for software, the installation processing unit 1606 does not install the dependency software.

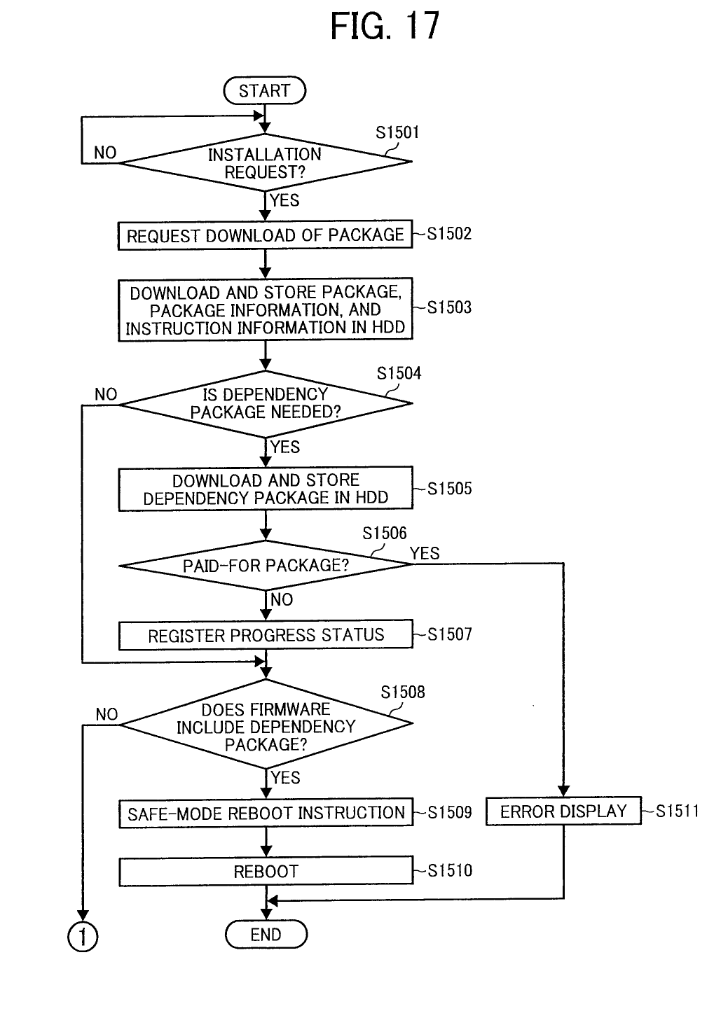

An installation process of the third embodiment with the configuration described above is described below. FIG. 17 is a flowchart illustrating a procedure of the installation process in accordance with the third embodiment. The processes from Step S1501 to S1505 are performed in the same way as those in the first embodiment.

After Step S1505, the determining unit 1604 determines whether the dependency software is paid-for software or not (Step S1506). When the dependency software is paid-for software (Step S1506: Yes), an indication of an error is displayed on the operational panel (Step S1511) and then the procedure is terminated. Thus, neither the acquisition nor the installation of the dependency software is carried out.

There are various ways of displaying an error. For example, an error message stating “the dependency software cannot be installed” or the like may be displayed on the operation panel in association with an install-target software ID.

When the dependency software is not paid-for software at Step S1506 (Step S1506: No), the acquisition and the installation of the dependency software are carried out through the same processes as those in the first embodiment (Steps 1507 to 1510).

When the dependency software of the install-target software is paid-for software in the present embodiment, neither the acquisition nor the installation of the dependency software is carried out. Thus, the present embodiment can prevent the user from being charged an unexpected fee for the MFP 100 on which the dependency software of the install-target software is to be automatically installed and can display such an indication, whereby the user-friendliness can be enhanced.

When the install-target software and the dependency software are already installed in the MFP 100 in a fourth embodiment, the version of the install-target software is compared, based on the package information from the software delivery server 500, with the version of the same software that has been already installed in the MFP 100. When the version is the same, the installation of the software is not carried out.

The network configuration of the software delivery system, the entire configuration of the MFP 100, and the functional configuration of the software delivery server in accordance with the present embodiment are the same as those in the first embodiment.

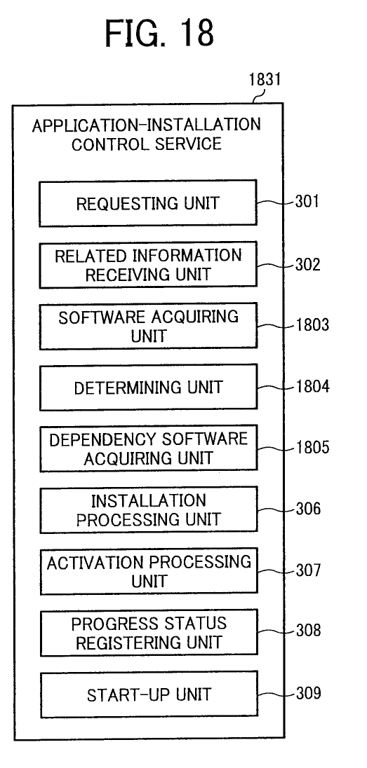

FIG. 18 is a block diagram illustrating a functional configuration of the application-installation control service 1831 of the MFP in accordance with the fourth embodiment. As illustrated in FIG. 18, the application-installation control service 1831 of the present embodiment mainly includes the requesting unit 301, the related information receiving unit 302, a software acquiring unit 1803, a determining unit 1804, a dependency software acquiring unit 1805, an installation processing unit 1806, the activation processing unit 307, the progress status registering unit 308, and the start-up unit 309.

The functions and configurations of the requesting unit 301, the related information receiving unit 302, the activation processing unit 307, the progress status registering unit 308, and the start-up unit 309 are the same as those in the first embodiment.

The determining unit 1804 of the present embodiment compares the versions described in the <version> tags in the package contents of the package information and the dependency information with the versions of the install-target software and the dependency software in the installed software list in the apparatus information and then determines whether the versions are the same, respectively.

When the version of the install-target software of the package information received from the software delivery server 500 is the same as the version of the install-target software in the installed software list in the apparatus information, the software acquiring unit 1803 does not download the package of the install-target software.

Further, when the version of the dependency information in the package information received from the software delivery server 500 is the same as the version of the dependency software in the installed software list in the apparatus information, the dependency software acquiring unit 1805 does not download the dependency software similarly. Accordingly, as for the same version of the software, the installation processing unit 1806 does not carry out the installation of the install-target software and the dependency software.

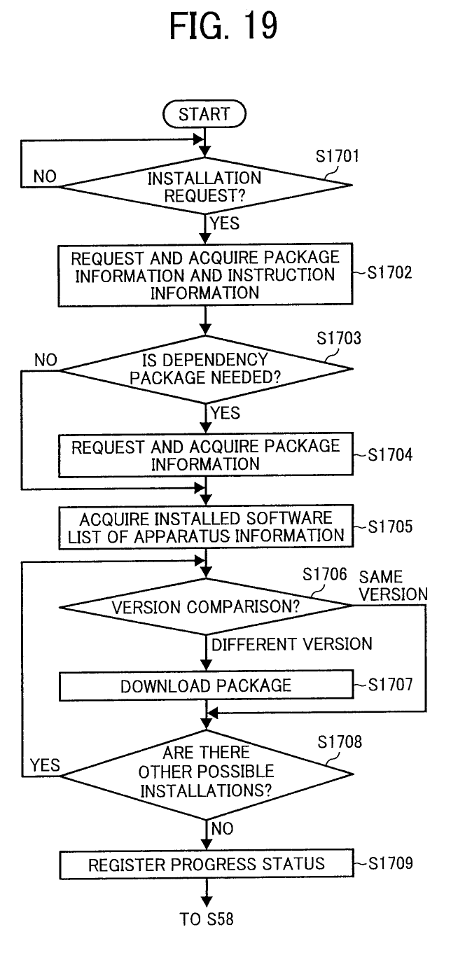

Further, the installation process of the fourth embodiment with the configuration described above is described below. FIG. 19 is a flowchart illustrating a procedure of the installation process in accordance with the fourth embodiment.

When there is an installation instruction from the requesting unit 301 (Step S1701: Yes), a related information receiving unit 1302 sends an installation request to the software delivery server 500 and downloads the package information of the install-target software and the instruction information (Step S1702).

Further, the determining unit 1804 determines, based on the received package information, whether the dependency software is needed or not (Step S1703). When it is determined that the dependency software is needed (Step S1703: Yes), the related information receiving unit 302 sends a request to the software delivery server 500 and downloads the package information of the dependency software (Step S1704).

Then, the determining unit 1804 acquires the installed software list in the apparatus information stored in the HDD 103 (Step S1705).

Then, the determining unit 1804 compares the version described in the package information with the version of the corresponding software in the apparatus information (Step S1706). When the versions are different, the determining unit 1804 downloads the software package (Step S1707).

In contrast, when the versions are the same, the software package is not downloaded. Then, the determining unit 1804 continues to carry out the processes, the version comparison and the software package downloading (Steps S1706, S1707), on all software to be installed (i.e., install-target software, dependency software, and the like) (Step S1708). The subsequent processes are carries out in the same way as the first embodiment (Step 1706 or 1709).

When the install-target software and the dependency software are already installed in the MFP 100 in the present embodiment, the version of the install-target software is compared, based on the package information from the software delivery server 500, with the version of the same software installed in the MFP 100. When the versions are the same, the installation is not carried out. Therefore, the installation is not carried out for the software of the same version, whereby the installation processing time can be shortened and user-friendliness can be enhanced.

When the install-target software and the dependency software are already installed in the MFP 100 in a fifth embodiment, the version of the install-target software is compared, based on the package information from the software delivery server 500, with the version of the same software installed in the MFP 100. Even when the versions are different, the installation is not carried out if the versions are compatible.

The network configuration of the software delivery system, the entire configuration of the MFP 100, and the functional configuration of the software delivery server 500 of the present embodiment are the same as those in the first embodiment.

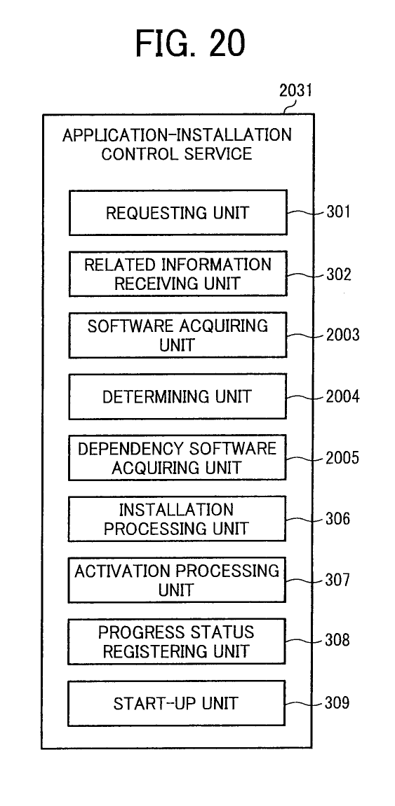

FIG. 20 is a block diagram illustrating a functional configuration of the application-installation control service 2031 of an MFP in accordance with the fifth embodiment. As illustrated in FIG. 20, the application-installation control service 2031 of the present embodiment mainly includes the requesting unit 301, the related information receiving unit 302, a software acquiring unit 2003, a determining unit 2004, a dependency software acquiring unit 2005, an installation processing unit 2006, the activation processing unit 307, the progress status registering unit 308, and the start-up unit 309.

The functions and configurations of the requesting unit 301, the related information receiving unit 302, the activation processing unit 307, the progress status registering unit 308, and the start-up unit 309 are the same as those in the first embodiment.

In the present embodiment, similarly to the fourth embodiment, the determining unit 2004 compares the versions described in the <version> tags of the package contents and the dependency information in the package information received from the software delivery server 500 with the versions of the install-target software and the dependency software in the installed software list in the apparatus information and then determines whether the versions are the same, respectively. Further, when the versions are different, the determining unit 2004 determines whether the versions are compatible.

Even when the version of the install-target software in the package information received from the software delivery server 500 is different from the version of the install-target software in the installed software list in the apparatus information, the software acquiring unit 2003 does not download the package of the install-target software if the versions are compatible.

Further, even when the version of the dependency information in the package information received from the software delivery server 500 is different from the version of the dependency software in the installed software list in the apparatus information, the dependency software acquiring unit 2005 does not also download the dependency software if the versions are compatible. Accordingly, the installation processing unit 2006 does not carry out the installation of the install-target software and the dependency software when the software versions are different but compatible.

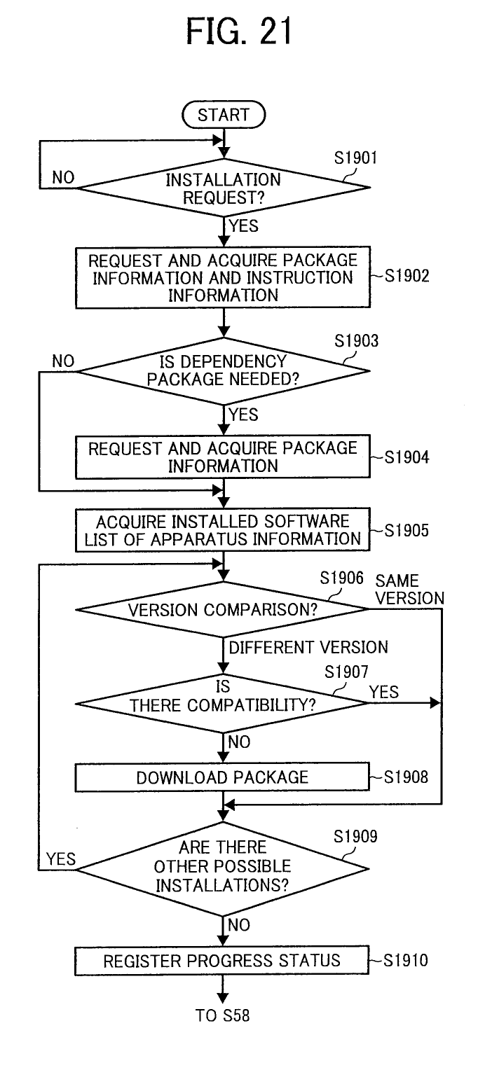

An installation process of the fifth embodiment with the above configuration is described. FIG. 21 is a flowchart illustrating a procedure of the installation process of the fifth embodiment. The processes from Steps S1901 to S1906 are performed in the same way as the fourth embodiment.

When the versions are different as a result of the comparison at Step S1906 (Step S1906: different version), the determining unit 2004 determines whether the versions are compatible or not (Step S1907). When the versions are not compatible (Step S1907: No), the software package is downloaded (Step S1908).

In contrast, when the versions are compatible, the software package is not downloaded. Then, the determining unit 2004 continues to carry out the processes, the version comparison, the determination of version compatibility and the software package downloading (Steps S1906 to S1908), on all software to be installed (i.e., install-target software, dependency software, and the like) (Step S1708). The subsequent processes are carries out in the same way as the first embodiment (Step 1909, 1906 or 1910).

When the install-target software and the dependency software are already installed in the MFP 100, the version of the install-target software is compared, based on the package information from the software delivery server 500, with the version of the same software installed in the MFP 100. When the versions are different but compatible, the installation is not carried out. Therefore, the present embodiment prevents the overlapped software from being installed without any check so that the operation of the MFP 100 never encounters a problem caused by a combination of a plurality of pieces of software.

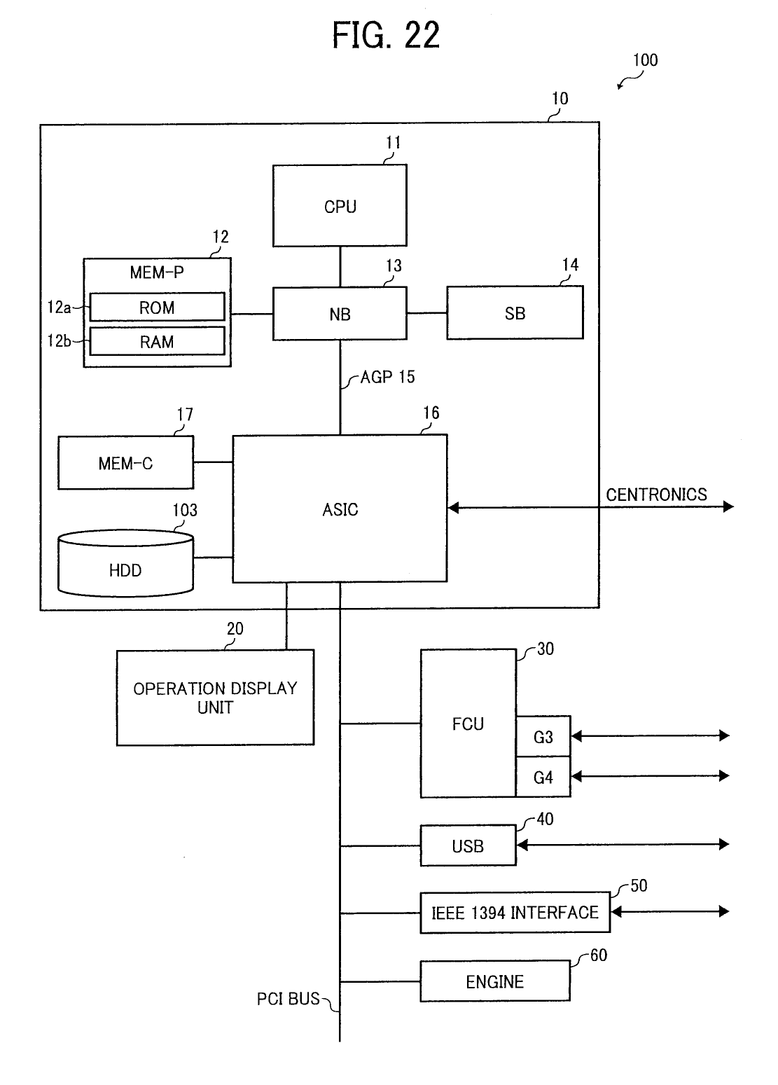

FIG. 22 is a block diagram illustrating a hardware configuration of the MFP 100 in accordance with the embodiment above. As illustrated in FIG. 22, the MFP 100 is configured in a manner such that a controller 10 is connected with an engine part (Engine) 60 via a PCI (Peripheral Component Interface) bus. The controller 10 is a controller that controls over the entire MFP 100, drawing, transmission, and input from an operating unit (not shown). The engine part 60 is a printer engine that can be connected to a PCI bus, e.g., a white-and-black plotter, 1-color drum plotter, four-color drum plotter, scanner, and a fax unit. The engine part 60 includes an engine part, such as a plotter, and a data processing part for, e.g., error diffusion and gamma conversion.

The controller 10 includes a CPU 11, a north bridge (NB) 13, a system memory (MEM-P) 12, a south bridge (SB) 14, a local memory (MEM-C) 17, an ASIC (Application Specific Integrated Circuit) 16, and the HDD 103. Further, the MEM-P 12 includes a ROM (Read Only Memory) 12a and a RAM (Random Access Memory) 12b.

The CPU 11 controls the entire control over the MFP 100. The CPU 11 includes a chipset consisting of the NB 13, the MEM-P 12, the SB 14, and the like. The CPU 11 is connected with other devices via the chipset.

The NB 13 is a bridge for connecting the CPU 11 with the MEP-P 12, the SB 14, and an AGP 15. The NB 13 includes a memory controller for controlling read/write to the MEP-P 12, and also includes a PCI master and an AGP target.

The MEM-P 12 is a system memory consisting of the ROM 12a and the RAM 12b and is used as a memory for extracting programs and data or a drawing memory of a printer. The ROM 12a is a read-only memory that is used as a memory for storing therein programs and data. The RAM 12b is a writable and readable memory that is used as a memory for extracting programs and data or a drawing memory of a printer.

The SB 14 is a bridge for connecting the NB 13 with a PCE device and other devices. The SB 14 is connected with the NB 13 via the PCI bus, to which a network interface (I/F) unit is also connected.

The ASIC 16 is an IC (Integrated Circuit) that includes a hardware component for image processing and is used for the image processing. The ASIC 16 includes a PCI target and an AGP master, and an arbiter (ARB) that is the core part of the ASIC 16, a memory controller that controls the MEM-C 17, a plurality of DMACs that carry out rotation or the like of image data with hardware logic, and a PCI unit that carries out data transfer with the engine part 60 via the PCI bus. The ASIC 16 is directly connected via PCI bus with An FCU (Facsimile Control Unit) 30, an USB (Universal Serial Bus) 40, and an IEEE 1394 (Institute of Electrical and Electronics Engineers 1394) interface 50. An operation display unit 20 is directly connected with the ASIC 16.

The MEM-C 17 is a local memory that is used as a copy image buffer and sign buffer. The HDD 103 is a storage for storing image data, programs, font data, and forms.

The AGP 15 is a bus interface for a graphics accelerator card for accelerating graphics processing. The AGP 15 enhances the speed of the graphics accelerator card by directly accessing to the MEM-P 12 with high throughput.

Further, the installation program executed in the MFP 100 is previously provided inside the ROM and the like.

The installation program executed in the MFP 100 of the embodiment described above may be stored provided in an installable format or an executable format in a recording medium, a flexible disk (FD), a CD-R, and a DVD (Digital Versatile Disk), that can be read by a computer such as a CD-ROM and provided therewith.

The installation program executed in the MFP 100 of the embodiment described above may be stored in a computer that is connected to a network, e.g., the Internet, so that the installation program can be provided through downloading via the network. Further, the installation program executed in the MFP 100 of the embodiment above may be provided or delivered via a network, e.g., the Internet.

The installation program executed in the MFP 100 of the embodiment above has a module configuration including the components described above (requesting unit, related information receiving unit, software acquiring unit, determining unit, dependency software acquiring unit, installation processing unit, activation processing unit, progress status registering unit, and start-up unit). Using actual hardware, a CPU (processor) reads a software delivery program from the ROM and executes the software delivery program. Then, the components are loaded on a main memory device, whereby the requesting unit, the related information receiving unit, the software acquiring unit, the determining unit, the dependency software acquiring unit, the installation processing unit, the activation processing unit, the progress status registering unit, and the start-up unit are generated on the main memory device.

Further, the embodiment above describes a case where the image processing apparatus of the present invention corresponds to an MFP including at least two of copying, printing, scanning, and facsimile functions. However, the embodiment may be applied to any image processing apparatus including at least two of the following machines: copier, printer, scanner, and facsimile.

The embodiment above describes an installation of application software of the MFP 100. However, the embodiment may be applied to software that is not an application.

Further, a software delivery server 500, a license management server 400, and the web server 200 have a hardware configuration using an ordinary computer with a control apparatus, a storage apparatus such as a ROM and a RAM, an HDD, an external storage apparatus such as a CD drive, a display apparatus such as a display, and input apparatuses such a keyboard and a mouse.

The software delivery program executed in the software delivery server 500 of the embodiment above is stored in a recording medium such as CD-ROM, flexible disk (FD), CD-R, and DVD (Digital Versatile Disk) that can be read by a computer.

Further, the software delivery program executed in the software delivery server 500 of the embodiment above may be stored in a computer that is connected to a network, e.g., the Internet, so that the software delivery program can be provided through downloading via the network. Further, the software delivery program executed in the software delivery server 500 of the embodiment above may be provided or delivered through the network, e.g., the Internet.

Further, the software delivery program executed in the software delivery server 500 of the embodiment above may be previously stored in a ROM and the like and provided.

The software delivery program executed in the software delivery server 500 of the embodiment above has a module configuration including the components described above (the request receiving unit, the instruction information generating unit, and the transmission unit). Using actual hardware, the CPU (processor) reads a software delivery program from the storage medium described above and executes the software delivery program. Then, the components are loaded on a main memory device, whereby the request receiving unit, the instruction information generating unit and the transmission unit are generated on the main memory device.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus that is connected with a software delivery server that delivers software, comprising
a storage unit;
a requesting unit that transmits an installation request specifying an install-target software to the software delivery server;
a related information receiving unit that receives software information, indicating information on the install-target software, from the software delivery server as a response to the installation request;
a software acquiring unit that acquires the install-target software;
a determining unit that determines whether dependency information on dependency software that needs to be installed before the install-target software is installed in the software information and, when the dependency information is registered in the software information, further determines whether the dependency software is firmware;
a dependency software acquiring unit that acquires the dependency software when the dependency information is registered in the software information;
a progress status registering unit that registers, when the dependency information is firmware, a progress status indicating a step at which the install-target software and the firmware have been acquired in the storage unit;
a start-up unit that restarts, when the dependency software is firmware, the image processing apparatus; and
an installation processing unit that refers to the progress status and, after restarting by the start-up unit, carries out the installation process of the install-target software.

2. The image processing apparatus according to claim 1, wherein
the progress status registering unit registers, when an error occurs during installation process of software, a progress status indicating that an error has occurred during the installation of software in the storage unit,
the start-up unit restarts, when the error occurs during the installation of software, the image processing apparatus, and
the installation processing unit carries out again, after restarting, installation process of the software which has encountered the error registered in the progress status.

3. The image processing apparatus according to claim 1, wherein
the software acquiring unit receives the install-target software as a response to the installation request, and
the dependency software acquiring unit receives the dependency software from the software delivery server.

4. The image processing apparatus according to claim 1, wherein
the software acquiring unit receives the install-target software as a response to the installation request from the software delivery server, and
the dependency software acquiring unit acquires the dependency software from an external storage medium.

5. The image processing apparatus according to claim 4, wherein
the dependency software acquiring unit further receives, when the dependency software is not stored in the external storage medium, the dependency software from the software delivery server.

6. The image processing apparatus in accordance with claim 1, wherein
the determining unit determines, based on the dependency information of the software information, whether the dependency software is paid-for software, and
the installation processing unit does not carry out, when the dependency software is paid-for software, the installation of the dependency software.

7. The image processing apparatus according to claim 1, wherein
the storage unit further stores therein apparatus information registered with installed software that is installed in the image processing apparatus and a version of the installed software,
the determining unit
determines, based on the apparatus information, whether the install-target software and the dependency software are installed software or not and,
when the install-target software or the dependency software is the installed software, determines whether the version of the install-target software or the dependency software is the same as a version of the installed software based on the apparatus information and the software information, and
the installation processing unit does not carry out installation of a version of software where the version of the software is the same as the version of the software, when the version of the install-target software or the dependency software is the same as the installed software.

8. The image processing apparatus according to claim 1, wherein
the software acquiring unit does not acquire software whose version is the same as a version of the install-target software or the dependency software that has been installed in the image processing apparatus.

9. The image processing apparatus according to claim 7, wherein
the determining unit determines, when a version of the install-target software or the dependency software is different from a version of the installed software, whether the versions are compatible based on the software information, and
the installation processing unit does not carry out installation of software whose version is different, when the versions are compatible.

10. The image processing apparatus according to claim 8, wherein
the determining unit determines, when a version of the install-target software or the dependency software is different from a version of the installed software, whether the versions are compatible based on the software information, and
the installation processing unit does not carry out installation of software whose version is different, when the versions are compatible.

11. The image processing apparatus according to claim 9, wherein
the software acquiring unit does not acquire a software whose version is different, when the versions are compatible.

12. The image processing apparatus according to claim 10, wherein
the software acquiring unit does not acquire a software whose version is different, when the versions are compatible.

13. The image processing apparatus in accordance with claim 1, wherein
the related information receiving unit further receives instruction information indicating instructions of processes related to the installation of the install-target software as a response to the installation request, and
the installation processing unit carries out the installation according to the instruction information.

14. The image processing apparatus according to claim 13, further comprising
an activation processing unit that carries out an activation process of the software according to the instruction information.

15. The image processing apparatus according to claim 1, wherein
the install-target software is software of an application executable in the image processing apparatus.

16. A software delivery system comprising:
a software delivery server that delivers software; and
an image processing apparatus that is connected with the software delivery server via a network and installs the software,
the image forming apparatus including
a first storage unit;
a requesting unit that sends an installation request specifying install-target software to the software delivery server;
a related information receiving unit that receives software information, indicating information on the install-target software, from the software delivery server as a response to the installation request;
a software acquiring unit that acquires the install-target software;
a determining unit that determines whether dependency information on dependency software that needs to be installed before the install-target software is installed in the software information and, when the dependency information is registered in the software information, further determines whether the dependency software is firmware;
a dependency software acquiring unit that acquires the dependency software when the dependency information is registered in the software information;
a progress status registering unit that registers, when the dependency information is firmware, a progress status indicating a step at which the install-target software and the firmware have been acquired in the first storage unit;
a start-up unit that restarts, when the dependency software is firmware, the image processing apparatus; and
an installation processing unit that refers to the progress status and, after the restarting, carries out the installation process of the install-target software; and
the software delivery server including a second storage unit that stores therein the software information for each software;
a request receiving unit that receives the installation request; and
a related information transmission unit that acquires the software information on the install-target software, to which the installation request has been sent, from the second storage unit and transmits the software information acquired to the image processing apparatus as a response to the installation request.

17. The software delivery system according to claim 16, wherein
the image processing apparatus further includes an activation processing unit that carries out an activation process of the install-target software,
the first storage unit of the image processing apparatus stores a list of installed software that has been installed on the image processing apparatus, and stores apparatus information on the status on activation of the installed software,
the requesting unit of the image processing apparatus transmits the apparatus information to the software delivery server along with the installation request, and
the software delivery server further includes an instruction information generating unit that generates instruction information indicating instructions on processes of installation and activation of the install-target software, wherein
the related information transmission unit of the software delivery server further transmits the instruction information to the image processing apparatus as a response to the installation request,
the installation processing unit of the image processing apparatus carries out an installation process according to the instruction information, and
the activation processing unit of the image processing apparatus carries out an activation process according to the instruction information.

18. An installation method that is employed in a software delivery system including a software delivery server that delivers software and an image processing apparatus that connected with the software delivery server via a network and installs the software,
the image forming apparatus including a first storage unit and
the software delivery server including a second storage unit that stores therein the software information indicating information on each software, the installation method comprising:
a requesting step where a requesting unit of the image processing apparatus sends an installation request specifying install-target software to the software delivery server;
a step where a request receiving unit of the software delivery server receives the installation request;
a step where a related information transmission unit of the software delivery server transmits the software information on the install-target software, to which the installation request has been sent, and the install-target software to the image processing apparatus as a response to the installation request;
a step where a related information receiving unit of the image processing apparatus receives the software information of the install-target software as a response to the installation request;
a step where a software acquiring unit of the image processing apparatus acquires the install-target software;
a step where a determining unit of the image processing apparatus
determines whether dependency information on dependency software that needs to be installed before the install-target software is installed and,
when the dependency information is registered in the software information, further determines whether the dependency software is firmware;
a step where a dependency software acquiring unit of the image processing apparatus acquires the dependency software when the dependency information is registered in the software information;
a step where a progress status registering unit of the image processing apparatus registers, when the dependency information is firmware, a progress status indicating that the install-target software and the firmware have been acquired in the first storage unit;
a step where the start-up unit of the image processing apparatus restarts, when the dependency software is firmware, the image processing apparatus; and
a step where an installation processing unit of the image processing apparatus, after the restarting, refers to the progress status and carries out the installation process of the install-target software.
